(19) United States
(12) Patent Application Publication
(10) Pub. No.: US 2013/0138482 A1
(43) Pub. Date: May 30, 2013

(54) CAPITAL ASSET PLANNING SYSTEM

(71) Applicants: Roger N. Anderson, New York, NY (US); Maggie Chow, Hartsdale, NY (US); Albert Boulanger, New York, NY (US)

(72) Inventors: Roger N. Anderson, New York, NY (US); Maggie Chow, Hartsdale, NY (US); Albert Boulanger, New York, NY (US)

(21) Appl. No.: 13/479,198

(22) Filed: May 23, 2012

Related U.S. Application Data
(63) Continuation of application No. 13/274,770, filed on Oct. 17, 2011, now abandoned.
Application No. 13/274,770 is a continuation of application No. PCT/US2010/036717, filed on May 28, 2010.
(60) Provisional application No. 61/182,085, filed on May 28, 2009.

(51) Int. Cl. G06Q 10/06

(52) U.S. Cl. CPC G06Q 10/06375
USPC 705/7.37

(57) ABSTRACT

A capital asset planning system for selecting assets for improvement within an infrastructure that includes one or more data sources descriptive of the infrastructure, one or more databases, coupled to the one or more data sources, to compile the one or more data sources, one or more processors, each coupled to and having respective communication interfaces to receive data from the one or more databases. The processor includes a predictor to generate a first metric of estimated infrastructure effectiveness based, at least in part, on a current status of the infrastructure, a second metric of estimated infrastructure effectiveness based, at least in part, on a user-selected, proposed changed configuration of the infrastructure, and a net metric of infrastructure effectiveness based, at least in part, on said first metric and said second metric. The system also includes a display, coupled to have the one or more processors, for visually presenting the net metric of infrastructure effectiveness, in which the assets for improvement are selected based, at least in part, on the net metric of infrastructure effectiveness.

### CROSS-REFERENCE TO RELATED APPLICATIONS

This application is a continuation of U.S. Nonprovisional patent application Ser. No. 13/274,770 filed Oct. 17, 2011, and claims priority to International Patent Application Serial No. PCT/US2010/036717 filed May 28, 2010, and claims priority to U.S. Provisional Application Ser. No. 61/182,085 filed on May 28, 2009, the contents of all of which are hereby incorporated by reference in their entireties herein.

### COPYRIGHT NOTICE

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

### FIELD

The disclosed subject matter relates to techniques for prioritizing use of capital assets for infrastructure improvements using a capital asset planning tool (CAPT) system.

### BACKGROUND

Infrastructures, particularly mature infrastructures, are in constant need of improvement and upgrade. Furthermore, regulatory and environmental concerns dictate the removal of older equipment in favor of newer, more-efficient equipment. Due to commercial realities, there is a limited budget that is available for such improvements to infrastructure. There remains a need to logically and quantitatively determine which assets within a complex infrastructure to select for improvement in order to maximize the benefit obtained therefrom.

### SUMMARY

The present application provides methods and systems for prioritizing use of capital assets for infrastructure improvements.

One aspect of the present application provides a capital asset planning system for selecting assets for improvement within an infrastructure that includes one or more data sources descriptive of the infrastructure, one or more databases, coupled to the one or more data sources, to compile the one or more data sources, one or more processors, each coupled to and having respective communication interfaces to receive data from the one or more databases. The processor includes a predictor to generate a first metric of estimated infrastructure effectiveness based, at least in part, on a current status of the infrastructure, a second metric of estimated infrastructure effectiveness based, at least in part, on a user-selected, proposed changed configuration of the infrastructure, and a net metric of infrastructure effectiveness based, at least in part, on said first metric and said second metric. The system also includes a display, coupled to have the one or more processors, for visually presenting the net metric of infrastructure effectiveness, in which the assets for improvement are selected based, at least in part, on the net metric of infrastructure effectiveness.

Another aspect of the present application also provides a method for selecting assets for improvement within an infrastructure that includes accessing one or more data sources descriptive of the infrastructure, compiling the one or more data sources into one or more databases, generating a first metric of estimated infrastructure effectiveness based, at least in part, on a current status of the infrastructure, generating a second metric of estimated infrastructure effectiveness based, at least in part, on a user-selected, proposed changed configuration of the infrastructure, generating a net metric of infrastructure effectiveness based, at least in part, on said first metric and said second metric, and displaying the net metric of infrastructure effectiveness, in which the assets for improvement are selected based, at least in part, on the net metric of infrastructure effectiveness.

### BRIEF DESCRIPTION OF THE DRAWINGS

Further objects, features and advantages of the disclosed subject matter will become apparent from the following detailed description taken in conjunction with the accompanying figures showing illustrative embodiments of the disclosed subject matter, in which:

FIG. 1 depicts an exemplary web application layer (GUI) according to one CAPT embodiment of the presently disclosed subject matter.

FIG. 2 depicts CAPT system components and their relationship according to an exemplary embodiment of the present application.

FIG. 3 depicts the Feeder change evaluation ranking system that re-ranks feeders and updates Support Vector Machine scores to evaluate What-If impact from Capital or Operational changes such as those described in Tiers 1-4 according to one embodiment of the presently disclosed subject matter.

FIG. 4 depicts the goodness-of-fit validation method for establishing that the Predicted OA Feeder Failure Rate (1/MTBF) that is computed from a linear regression of the Machine Learning SVM scores and rankings of FIG. 4 represents a statistically valid representation of the Actual observed OA Feeder Failure Rate (1/MTBF).

FIG. 5 depicts the Graphical User Interface of a representative embodiment that presents options for Load Relief (Tier 1), PILC Section Replacement (Tier 2), Reliability Replacement (Tier 3) and LPW Selection (Tier 4). All critical component compositions of the feeder are displayed along with their baseline count and user selected new count.

FIG. 6 depicts the CAPT rollup view that lists the minimal costs per largest benefits attainable from replacement of a selectable percentage of bad components in each Tier.

FIG. 7 depicts a crossplot of % Delta MTBF (vertical y-axis) vs estimated costs (horizontal x-axis) used to evaluate which feeders in a given network or circuit provide the maximum benefit for optimal cost.

FIG. 8 depicts a Geographic Information System display (Google Earth) of the Machine Learning Ranking of each component section of each feeder in a representative network. The higher the “window pane”, the more susceptible each section is to impending failure.

FIG. 9 depicts a selected feeder from the FIG. 8 network with several candidate runs of PILC cable sections, the replacement of which will lower the risk (and lower the window pane height in the visual).

FIG. 10 depicts a zoom into the topological layout of the feeder (upper left, white box) that shows component by component connectivity between feeder sections and the manholes (M) containing the joints connecting the sections. T and V are transformers.

FIG. 11 depicts a screen shot of an exemplary embodiment of the CAPT tool evaluating Tier 1 Load Relief options for a representative feeder.

FIG. 12 depicts a drilldown into the Tier 1 Load Relief section selection process that displays the runs of overloaded cable sections that are to be selected from for possible replacement.

FIG. 13 depicts the predicted change in MTBF and Machine Learning susceptibility rank for the feeder if a recommended 55 most at-risk PILC sections from the Tier 2 PILC Replacement evaluation are made.

FIG. 14 depicts the replacement of 50% of the Stop Joints (total of 11) in a representative feeder during Tier 3 evaluation.

FIG. 15 depicts a screen capture of the CAPT tool Tier 4 evaluation of Load Pocket Weight repairs that are possible for a representative feeder.

FIG. 16 depicts the predicted MTBF improvement of 8 days if the changes selected in FIG. 15 are made, i.e., closing 8 open switches and repairing 4 Open Mains.

FIG. 17 depicts the Efficient Frontier of cost vs benefit (in MTBF Delta Days) for 50% and 100% PILC cable replacement options from Tier 2 evaluation.

While the disclosed subject matter will now be described in detail with reference to the figures, it is done so in connection with illustrative, non-limiting embodiments.

### DETAILED DESCRIPTION

One aspect of the present application provides a capital asset planning system for selecting assets for improvement within an infrastructure that includes one or more data sources descriptive of the infrastructure, one or more databases, coupled to the one or more data sources, to compile the one or more data sources, one or more processors, each coupled to and having respective communication interfaces to receive data from the one or more databases. The processor includes a predictor to generate a first metric of estimated infrastructure effectiveness based, at least in part, on a current status of the infrastructure, a second metric of estimated infrastructure effectiveness based, at least in part, on a user-selected, proposed changed configuration of the infrastructure, and a net metric of infrastructure effectiveness based, at least in part, on said first metric and said second metric. The system also includes a display, coupled to have the one or more processors, for visually presenting the net metric of infrastructure effectiveness, in which the assets for improvement are selected based, at least in part, on the net metric of infrastructure effectiveness.

In one embodiment, the first metric of infrastructure effectiveness and the second metric of infrastructure effectiveness are both based, at least in part, on an estimated length of time that the infrastructure produces a commodity. For example, the first metric of infrastructure effectiveness and the second metric of infrastructure effectiveness can be based, at least in part, on the estimated mean time between failure of one or more components of the electrical grid, such as the estimated mean time between failure of an electrical feeder. In other embodiments, the first metric of infrastructure effectiveness and the second metric of infrastructure effectiveness is estimated using a feeder index, the index based, at least in part, on a predicted likelihood of feeder failure. The feeder can be updated in view of changed conditions using machine learning.

In various embodiments, the infrastructure to which the capital asset planning system and methods of the presently disclosed subject matter can be applied to is without limitation. In one embodiment, the infrastructure is selected from the group consisting of a chemical processing operation, a petroleum refining operation, a product manufacturing operation, a telecommunication grid, a transportation infrastructure, a gas network, a commodity pipeline network, and a water treatment network.

In one embodiment, the infrastructure is an electrical grid. Data sources descriptive of the electrical grid include one or more of data representative of at least one of electrical feeder data, electrical cable data, electrical joint data, electrical transformer data, electrical outage data, electrical test pass or fail data, electrical load data, and past capital improvement cost data.

In certain embodiments of the presently disclosed subject matter, the predictor further generates a cost metric based, at least in part, on the cost of the user-selected, proposed change of the infrastructure. For example, the cost metric can be generated based, at least in part, on a user-specified cost of one or more specific actions encompassed by the user-selected, proposed change of the infrastructure. Alternatively, the cost metric is based, at least in part, on past capital improvement cost data. In one embodiment, the predictor further comprises a prioritizer to determine the user-selected, proposed changed configuration of the infrastructure that provides the maximum value based, at least in part, on the net metric of infrastructure effectiveness and the cost metric.

One aspect of the present application also provides a method for selecting assets for improvement within an infrastructure that includes accessing one or more data sources descriptive of the infrastructure, compiling the one or more data sources into one or more databases, generating a first metric of estimated infrastructure effectiveness based, at least in part, on a current status of the infrastructure, generating a second metric of estimated infrastructure effectiveness based, at least in part, on a user-selected, proposed changed configuration of the infrastructure, generating a net metric of infrastructure effectiveness based, at least in part, on said first metric and said second metric, and displaying the net metric of infrastructure effectiveness, in which the assets for improvement are selected based, at least in part, on the net metric of infrastructure effectiveness.

In one embodiment, the infrastructure is an electrical grid, and the first metric, the second metric and the net metric is based, at least in part, on the estimated mean time between failure of an electrical feeder within the electrical grid. Additionally, the first metric of infrastructure effectiveness and the second metric of infrastructure effectiveness can be estimated using a feeder index, the index based, at least in part, on a predicted likelihood of feeder failure. In one embodiment, the method further includes generating a cost metric based on the cost of the user-selected, proposed change of the infrastructure, such that cost benefit analysis can be performed, and the infrastructure receives a maximum bang for the buck.

In one embodiment, the present application provides methods and systems for quantitatively predicting an effectiveness of a proposed capital improvement project based on establishing the changes in attributes predicting feeder performance based on changes in assets from the improvement project and using either SVM raking then regression of ranks to MTBF or SVM Regression to estimate MTBF directly. In one embodiment, the benefit is the change in MTBF from the project and the cost is the cost of the project. The system allows comparison of cost vs. benefits amongst alternative projects given budget constraints providing an enhanced portfolio selection of projects.

As used herein, a “user-selected, proposed changed configuration of the infrastructure,” or more generally, a “capital improvement project” or an “improvement” to the infrastructure refers to any change in an infrastructure, including, but not limited to, the replacement of any one or more components of the infrastructure for any purpose, such as to improve the output of the infrastructure, for purposes of preventative maintenance, and/or for regulatory compliance.

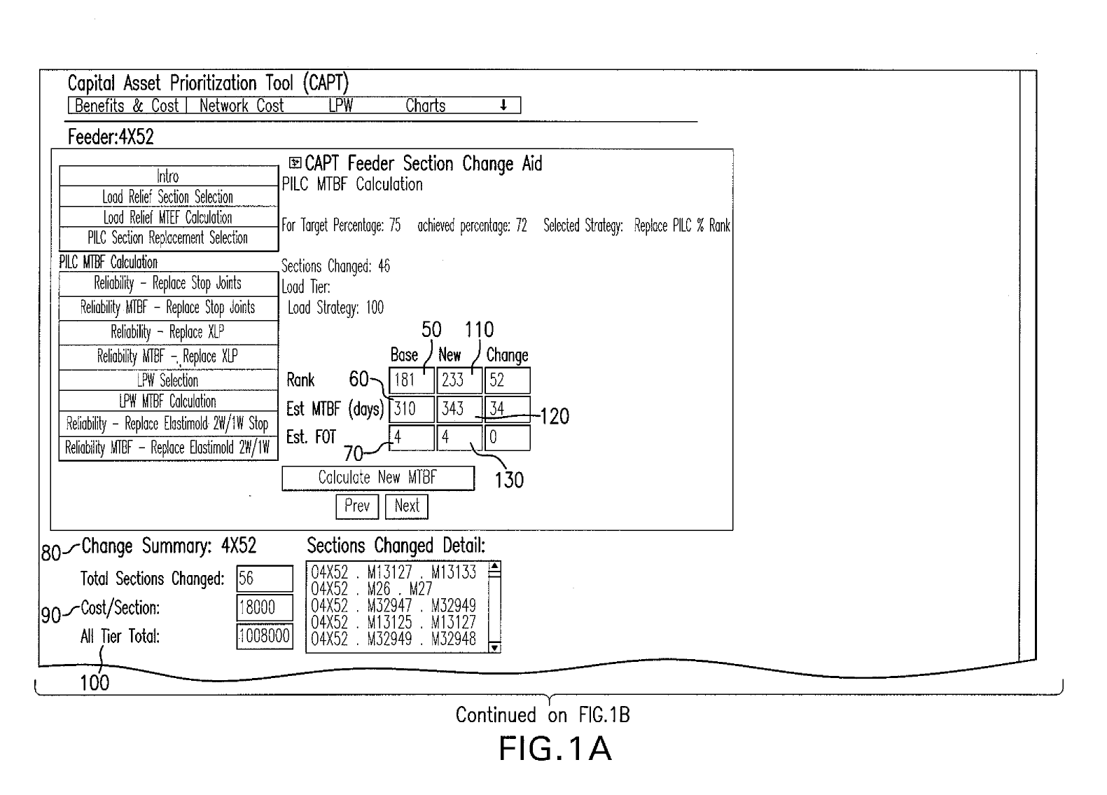

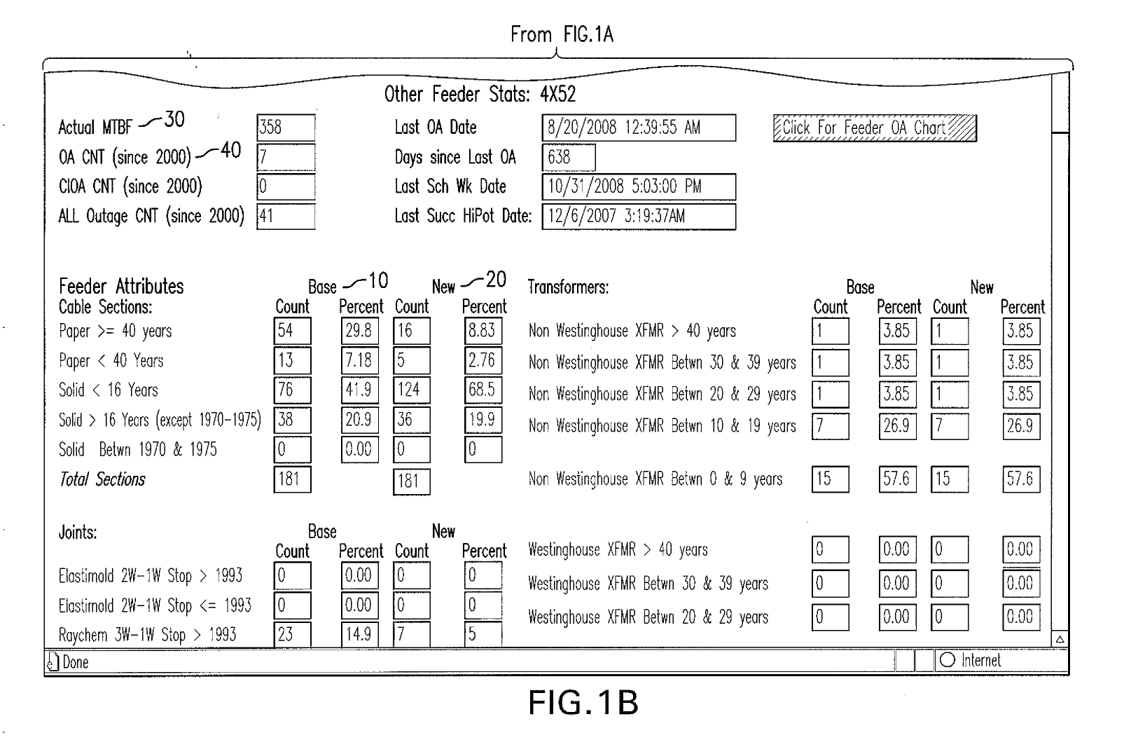

The presently disclosed subject matter can be further described with reference to the following non-limiting embodiments. In one particular embodiment, as shown in FIG. 1, the CAPT system is used to analyze how to improve an allocation of a fixed budget devoted to the modernization of cable (i.e., the replacement of older PILC cable (paper insulated lead cable insulation) to newer XLP cross-linked polyethylene insulation) and EPR (ethylene propylene rubber insulation) cable in a particular electrical distribution feeder (4X52) within an electrical grid.

The CAPT web application can be linked to database(s) that provides baseline feeder attributes (10) regarding, for example, the type of cable currently in place (e.g., paper insulated cable, etc.), connecting joints currently in place, and details regarding the transformers used in a particular feeder to convert power from distribution voltages to consumer voltages. The user can define a variety of proposed upgrades to these attributes (20), based on, for example, a) the percentage of PILC cable that is replaced, i.e., swapped out with more modern cable (e.g., XLP or EPR cable), b) load relief for overstressed cable and/or c) general system reliability and/or preventative maintenance. The CAPT web application layer can also be provided with historical data regarding observed failure and performance for the particular component mix of each individual feeder within a network, circuit, and electrical grid, such as actual MTBF (30), actual OA (Open Automatic feeder failures) counts (40), and actual replacement costs based on the actual performance history of each specific feeder of a network, circuit and electrical grid. Baseline feeder rankings (50), baseline estimated MTBF (60) and estimated FOT (failure on test) prediction data (70) can also be provided, based on the SVM model (either ranking or regression) and optionally, a regression (if SVM ranking is used) prediction that accounts for the particular feeder performance (here, 4X51) before any improvements have been made.

After the user has inputted details regarding the proposed changes, the CAPT system outputs summary data regarding the upgrade work proposed (80), including the estimated cost per section (90) and total cost (100) to perform the proposed work. These cost estimates can be determined based on the historical data for cable replacement efforts that is stored in the database for statistically similar feeders. Alternatively, the cost data can be a user-input field to account for particular features of the particular feeder, or simply a system wide estimate based on for example, previous work or public service commission data.

The CAPT web application, in communication with one or more processors, also outputs new feeder rankings (110), new estimated MTBF (120), and new estimated FOT (130) in view of the upgrades proposed. From these metrics, one can ascertain the statistically estimated (e.g., a SVM model based estimated) benefit of the proposed upgrades in view of the costs, i.e. a cost benefit analysis that determines the best overall “bang for the buck.” For the overall portfolio of replacement and preventive maintenance work being planned at each increment in time.

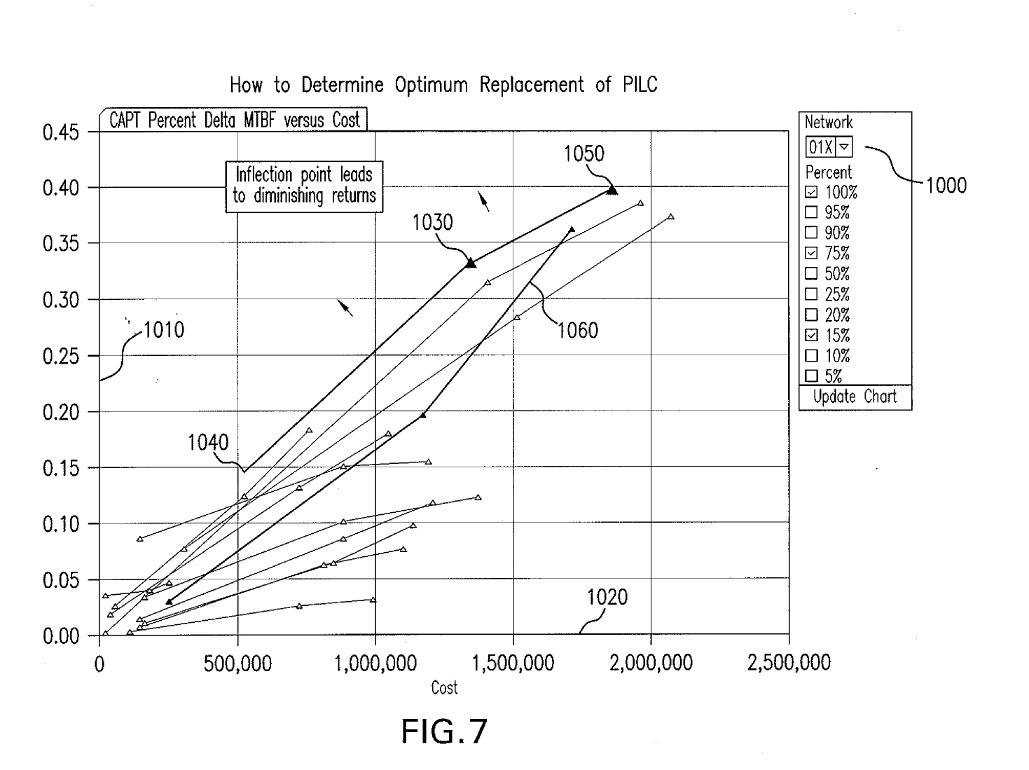

This output can be stored and analyzed vs., for example, predicted MTBF improvements of other proposed changes to determine how to best allocate a fixed budget that is devoted to this type of capital asset and operations and maintenance work. The CAPT system, and the CAPT web application specifically, offers the ability to graphically output this data point along with other data points derived from other proposed changes to other feeders or other possible replacement strategies and levels of replacement in the same feeder in graphical form to assist in budgeting (see FIG. 7), as for example in a Geographic Information System such as Google Earth or Microsoft Bling.

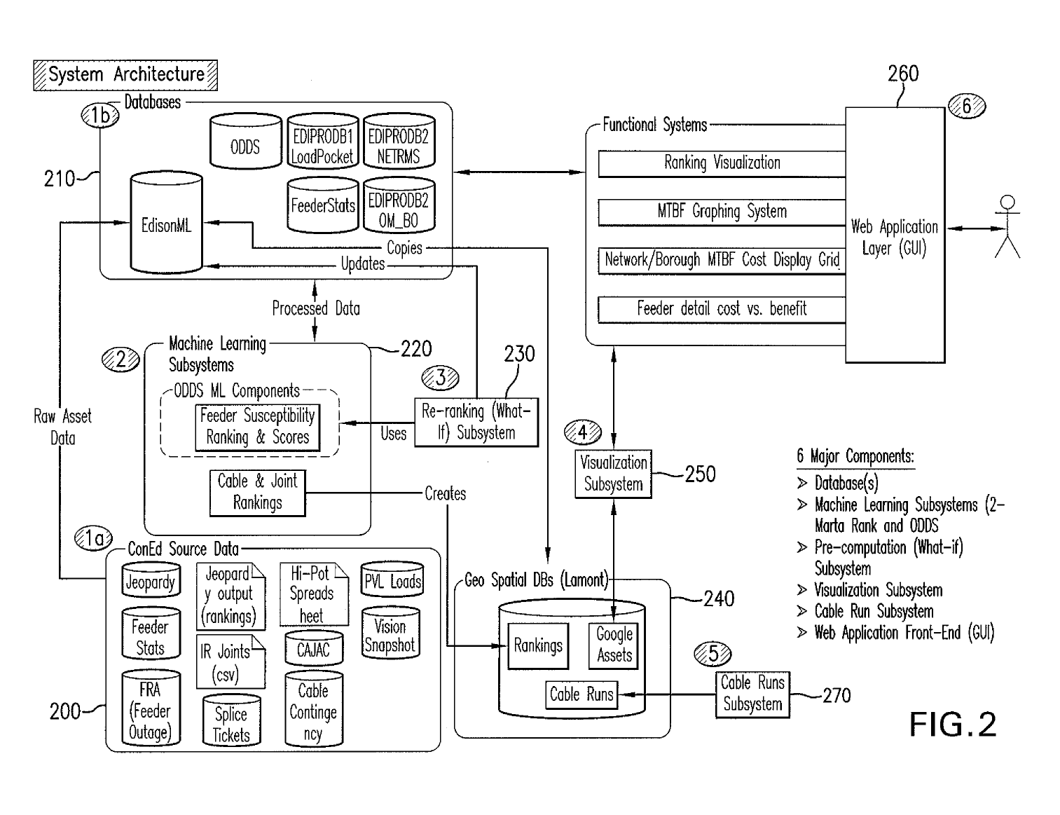

With reference to FIG. 2, an overview of an exemplary CAPT system architecture is provided. Source data (200) from the infrastructure (e.g., an electrical grid) is tapped, which includes, for example, data regarding the network topology, reliability (e.g., a network reliability index or “Jeopardy” database of most at risk networks and electrical feeders), feeder history and manufacturing statistics, outage and previous failure data, information from past capital improvement project costs and benefits, past electric load data, electrical cable component data by section and joint, transformer data, secondary low voltage electrical cable (main) data, GIS and mapping tool outputs such as Contingency Analysis and performance variances, systems and Hi-Pot ranking data (data used to derive a score for deciding which feeders to perform high potential tests in which voltage for a feeder that is over its normal operating voltage is applied to the feeder to stress the feeder and test its reliability).

This data is sent to databases (210) that compile all source data SVM modeling inputs and outputs in order to organize it into a form conducive for further analysis and data mining. Non-limiting databases for use in accordance with the presently disclosed subject matter include Vision Snapshot and Jeopardy database, which includes cable, joint, transformer data. The databases also include “ODDS” data, which is a machine learning system that uses SVMs (support vector machines) to predict a ranking (or MTBF using SVM regression) from most likely to least likely feeders susceptible to impending failure. See, e.g., International Published PCT Application No. WO 09/117,742, hereby incorporated by reference in its entirety.

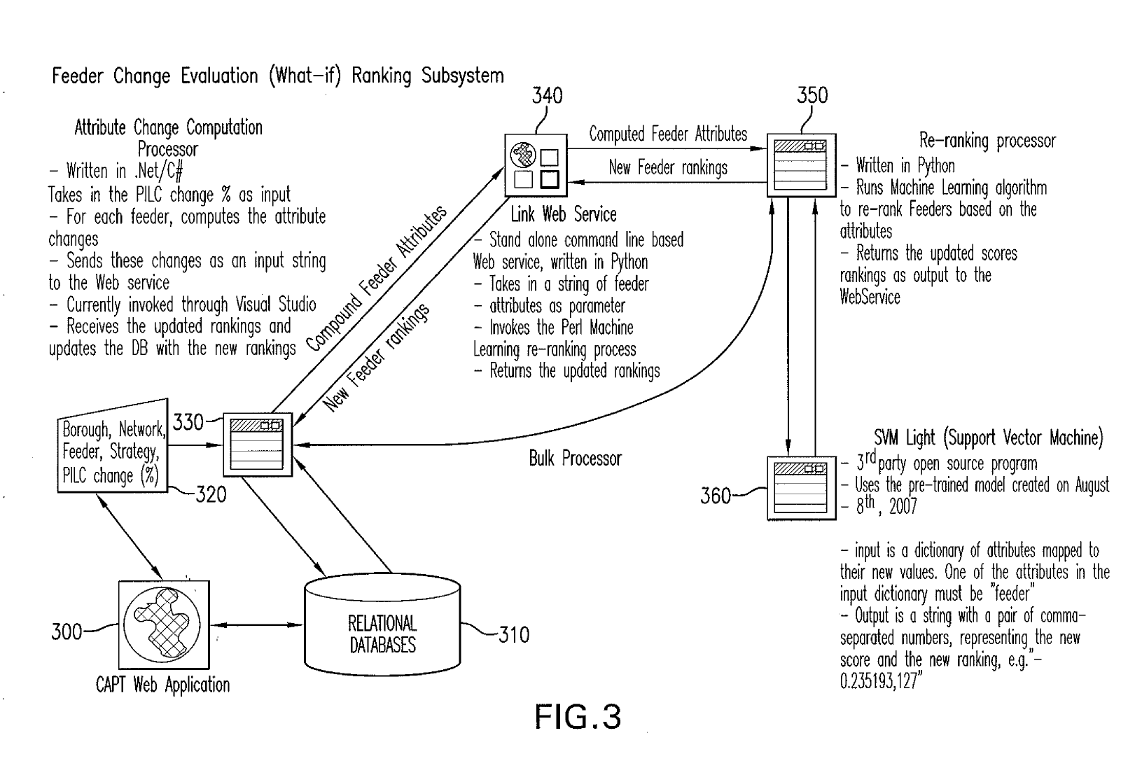

The databases are also in communication with other machine learning subsystems (220), that process data from the database and determines, for example, cable and joint rankings similar to the feeder rankings discussed above. The machine learning subsystems automatically rerank potential capital asset, operations, and maintenance work (230) according to the optimal mix of predicted benefits at the minimal costs as more data is continually received over time and changes are enacted on the real system based on the predictions of CAPT outputs (see FIG. 3).

In this example, the databases are also in communication with geospatial databases (240), including mapping data, such as Google Earth mapping data to create a GIS visualization subsystem (250). The geospatial database also receives data from a cable subsystem (270), that processes additional details regarding runs (a contiguous series) of the same type of cable.

The processed data from the database and visualization data from the visualization subsystem are communicated to the CAPT web application layer (GUI) (260), an example of which is provided in FIG. 1. The web application layer can output, among other things, ranking visualizations, MTBF graphing systems, network/borough MTBF vs. cost display grids and feeder cost benefit analysis details, including both tables and charts. Representative code for CAPT web application layer according to one specific embodiment of the present application is set forth in Appendix A. This program is in communication with the representative code set forth in Appendix C, which derives the new feeder attributes from the asset changes on the feeder.

Further details regarding feeder re-ranking data are provided in FIG. 3. The CAPT web application (300) is in communication with relational databases (310), examples of which are discussed throughout the application, and borough and network feeder parameters, strategies and cable, joint and transformer change options (PILC replacement percentages) (320). As shown in the Figure, the relational database is in communication with one or more of machine learning processors. These processors include an attribute change computation processor (330), which sends to the Link Web service the attributes for a changed feeder and receives updated rankings and updates the database with the new rankings. In this particular, non-limiting embodiment, the attribute change computation processor is written in .net/C#. For each feeder, attribute changes can be computed based on, among other things, changed sections selected by the CAPT interface, and the data is sent as an input string to the linked web service (340).

The linked web service can be a stand alone, command-line based web service that receives a string of feeder attributes as parameters and returns updated rankings and MTBF predictions. In this particular non-limiting embodiment, the link web service is written in Python programming language and invokes the Python-based Machine Learning re-ranking process.

The link web service can also be in communication with a re-ranking processor (350), also written in Python to return updated scores and rankings to the link web service. The re-ranking processor runs a machine learning algorithm such as ODDS to re-rank feeders based on MTBF improvement based on SVM processing of component attributes. Representative code for the re-ranking processor is set forth in Appendix B. This program is in communication with the representative code set forth in Appendix C, which derives the new feeder attributes from the asset changes on the feeder. The re-ranking processor can be in communication with the SVM Light processor (360). The SVM Light processor is a 3rd party open source program that receives an input of a dictionary of attributes mapped to their new values and outputs a string of comma-separated numbers representing the new ranking and/or MTBF.

As noted previously in connection with FIG. 1, embodiments of the presently disclosed subject maintain an actual baseline performance metric, and a predicted baseline performance metric. Comparison of the predicted performance metric with a predicted baseline performance metric can be preferable to comparing the predicted performance metric to the actually observed baseline performance metric, since it is best to be consistent in using the model to obtain both a baseline and projected changes to system performance. Upon receiving proposed capital, operations, and maintenance improvement funds, the actual vs predicted performance metrics are all updated. Providing the actually observed performance metrics therefore provides the “reality check,” in that by comparing the observed baseline performance metric to the predicted baseline performance metric, one can measure the extent to which the model matches the conditions actually observed in the field.

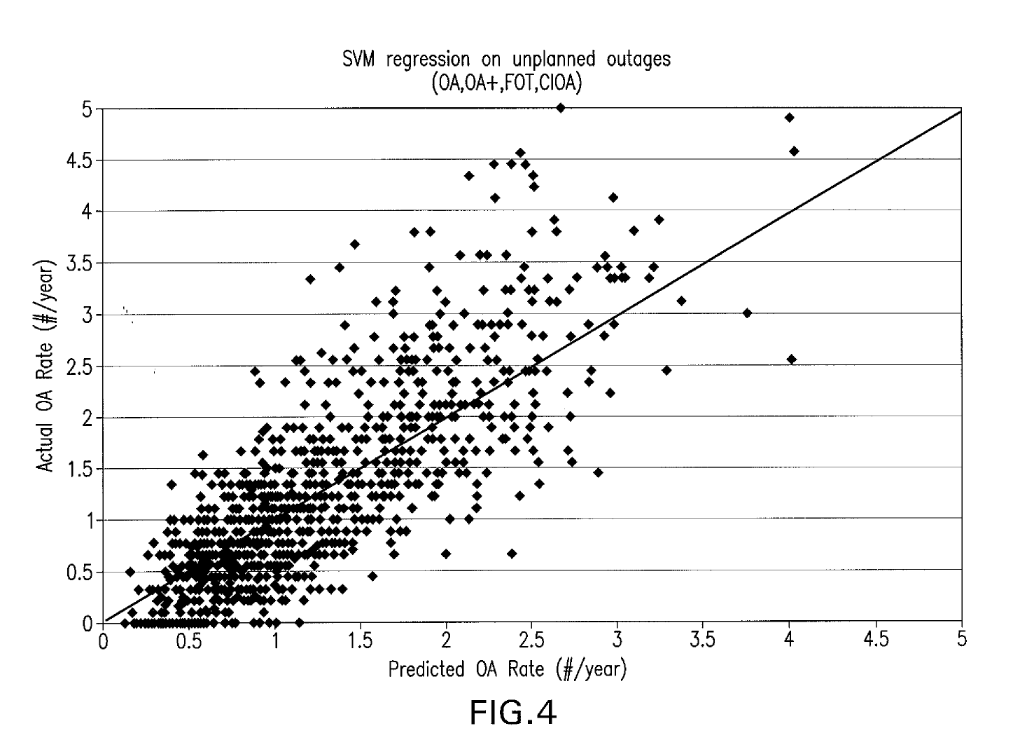

FIG. 4 plots the actual OA feeder failure rates versus the predicted OA feeder failure rates for underground feeders within a large and mature electrical grid in the northeast. The predicted OA rate is based on SVM regression. No further regression procedures, besides those associated with the SVM machine learning, need be employed. Alternatively, regression analysis can be performed on top of the SVM machine learning ranks.

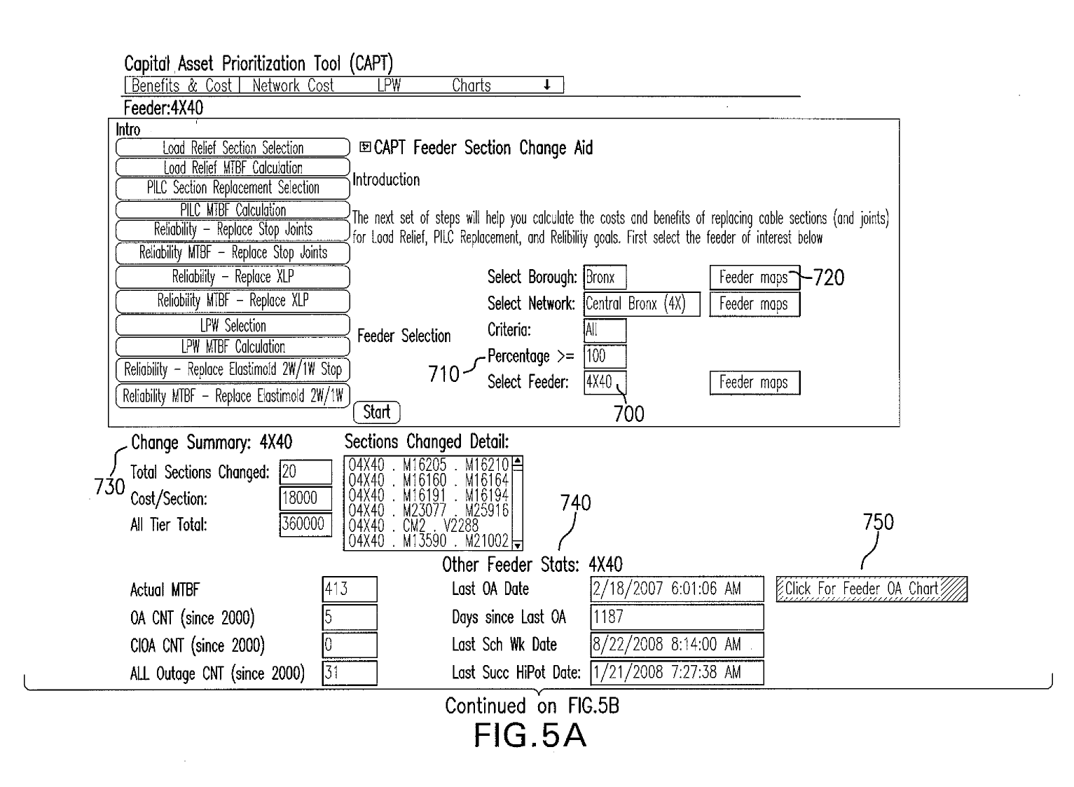

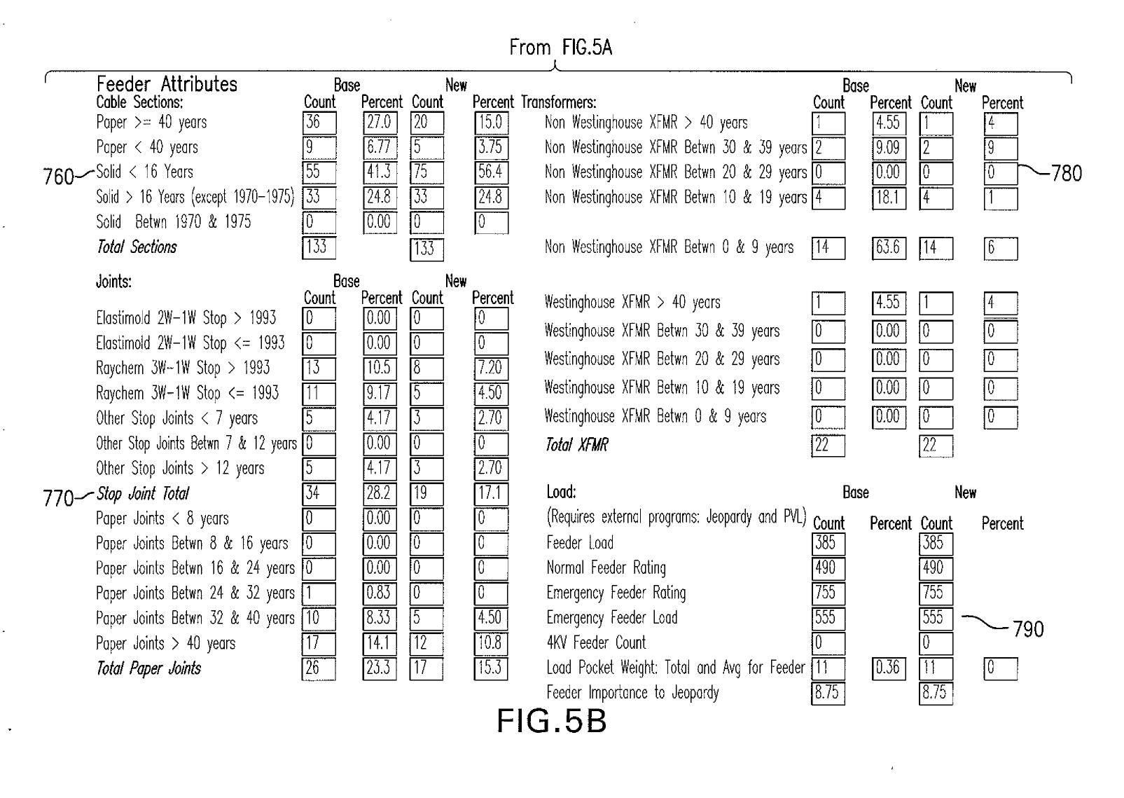

A non-limiting embodiment of a CAPT Feeder Section Change Aid is shown in FIG. 5, which allows users to calculate the cost and benefits of changing the mix of user-selected cable sections in view of, for example, Load Relief, PILC Replacement and/or preventative maintenance reliability goals. In this example, the proposed strategy of the capital improvements to the infrastructure is based on the feeder that the user selects (700), and the percentage of PILC cable that is replaced (here 100% or complete removal and replacement of PILC cable) (710). As shown on the right, the CAPT system is provided with mapping functionality (720) to assist the user in selecting the desired feeder sections.

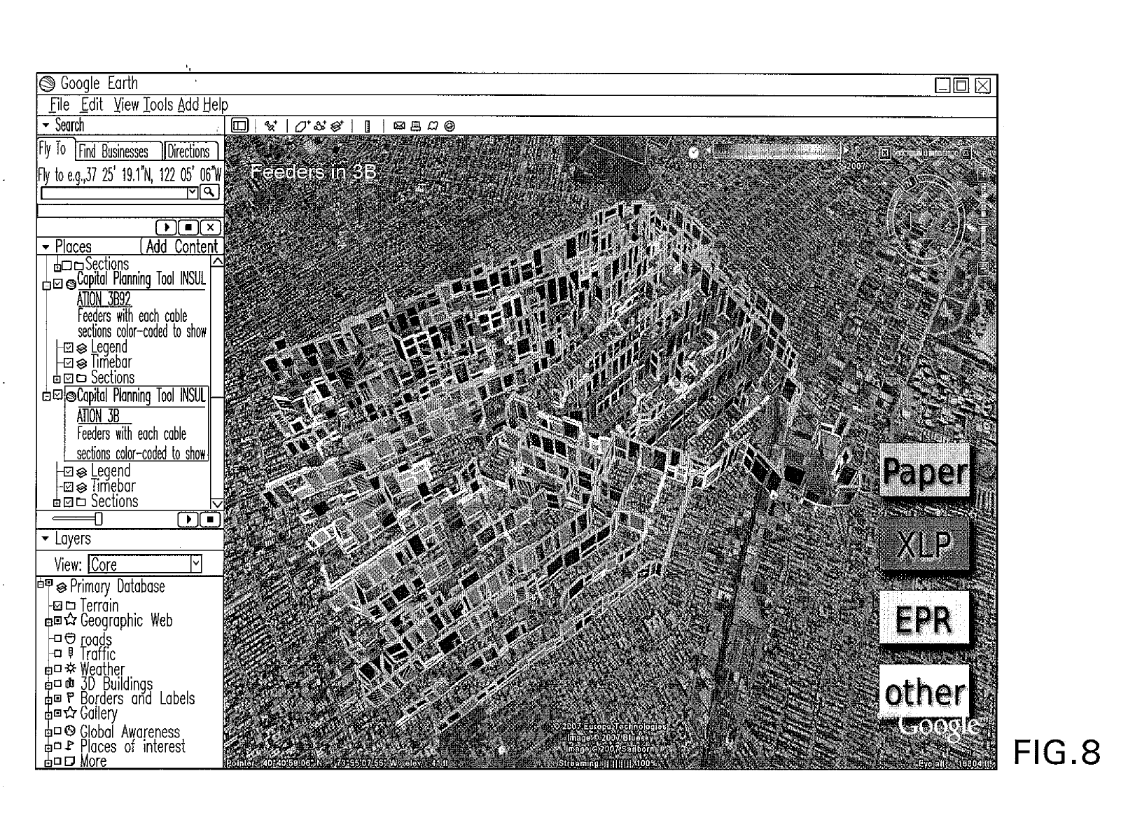

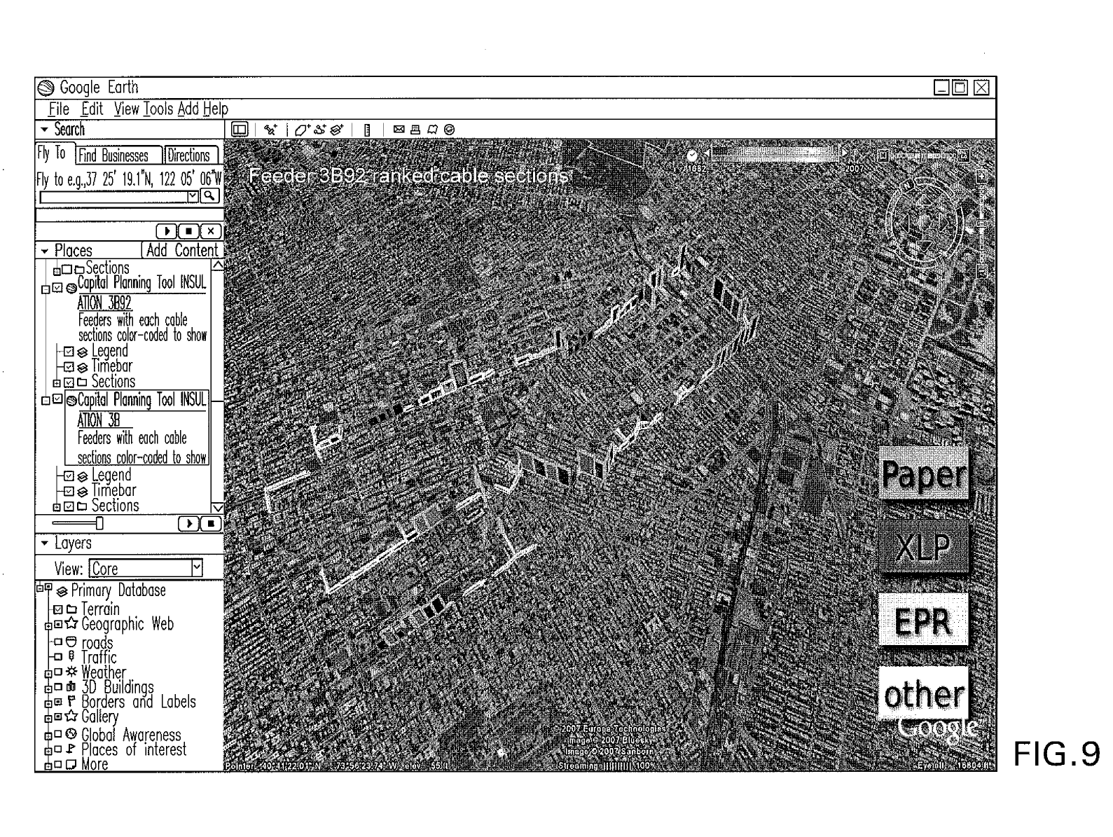

After the user inputs his or her selections from a set of possible strategies, the proposed changes are summarized in terms of the total sections of cable changed, the cost/section and the total cost of proposed upgrade (730). Other feeder statistics (740) are provided, including actual MTBF, OA feeder failure counts, entire outage counts that include scheduled outage work, and historical data regarding overall feeder performance. As shown on the right, charts (750) are available to visualize the cost vs. benefit tradeoffs of different replacement strategies and feeder selections (see FIGS. 8 and 9). Information about cable sections (760), “stop” joints (770) that connect PILC cable section types with XLP and EPR section types, transformers (780), and electric Load (790) on the feeder are also provided. This information is a subset of the attributes used in building the SVM model for predicting the MTBF of the feeder after vs before the contemplated changes are made.

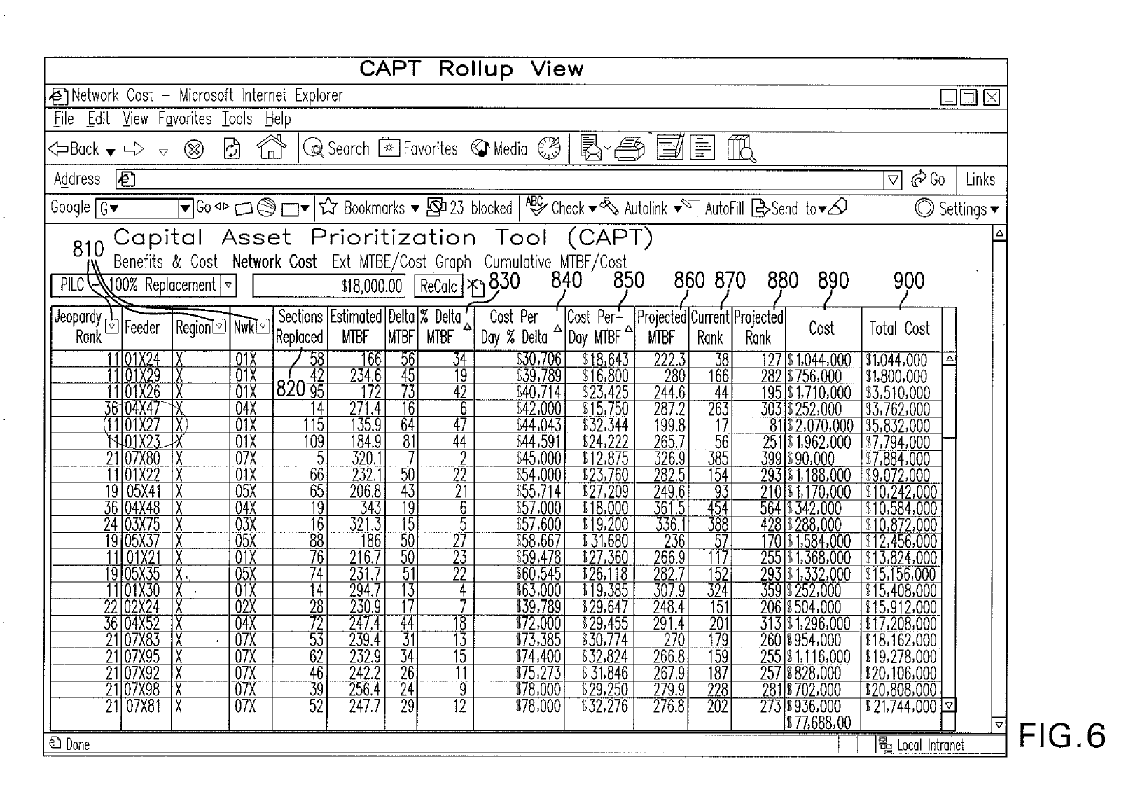

An exemplary output of the CAPT System is provided in FIG. 6, in which cost benefit data from various feeders are compared based on user-defined filters and sorts (810) (e.g. Jeopardy network reliability index, ODDS failure susceptibility index, feeder region). Capital improvement data, such as the number of PILC cable sections replaced (820) is also provided. In addition to estimated MTBF and the delta MTBF between predicted and baseline discussed above, the delta MTBF can be normalized by size or cost, such as a % Delta MTBF (830), and Cost Per Day % Delta (840). In this way a small change in MTBF for a poorly performing feeder with a small baseline MTBF can be established as more valuable than a large change in a good feeder with an already large MTBF because the % Delta MTBF will be higher. Running Cost per feeder (890) and running Total Cost (900) are also provided. In this particular embodiment, cost-per-day MTBF (850), Projected MTBF (860), Current rank before improvement (870) and Projected rank (880) after improvement are also provided.

FIG. 7 demonstrates a cost benefit analysis of proposed capital improvement projects in graphical form, which in turn can be used to determine replacement of PILC cable which provides the most bang for the buck. In this particular embodiment, one is trying to ascertain the cost vs. benefit of based on: a) 15% replacement of PILC cable in a given feeder; b) 75% replacement of PILC cable, and c) 100% replacement of PILC cable within a large, mature electrical grid in the northeast. The network (1000), and selection order of the PILC cable section replacement can also be specified. For a selected network, 100% PILC cable section replacement, sometimes called feeder “purification” or “backboning” efforts can be analyzed based on the benefit, i.e., the percent delta MTBF plotted along the y-axis (1010) against the cost of the feeder purification (1020) along the x-axis.

As can be ascertained from the line with the highest slope, one can visualize which capital improvement project obtains maximum “bang for the buck.” Inflection points, such as the decrease in marginal MTBF gains shown at (1030) indicate areas of diminishing returns. The highlighted line in FIG. 7 shows the percent delta MTBF for PILC cable replacement for feeder 1X23. The first point (1040) shows “bang for buck” given a 15% replacement, the second (1030) for 75% replacement and the third (1050) for 100% replacement of PILC. The CAPT system informs the user that it would be most effective to replace 75% of the PILC sections in this feeder, and devoting resources that would have been devoted to 100% replacement of PILC sections to more work on other feeders instead. For example, as to feeder 01X26, the CAPT system indicates that 100% replacement of PILC cable sections would provide more “bang for buck” as the slope from 75% to 100% (1060) is much higher.

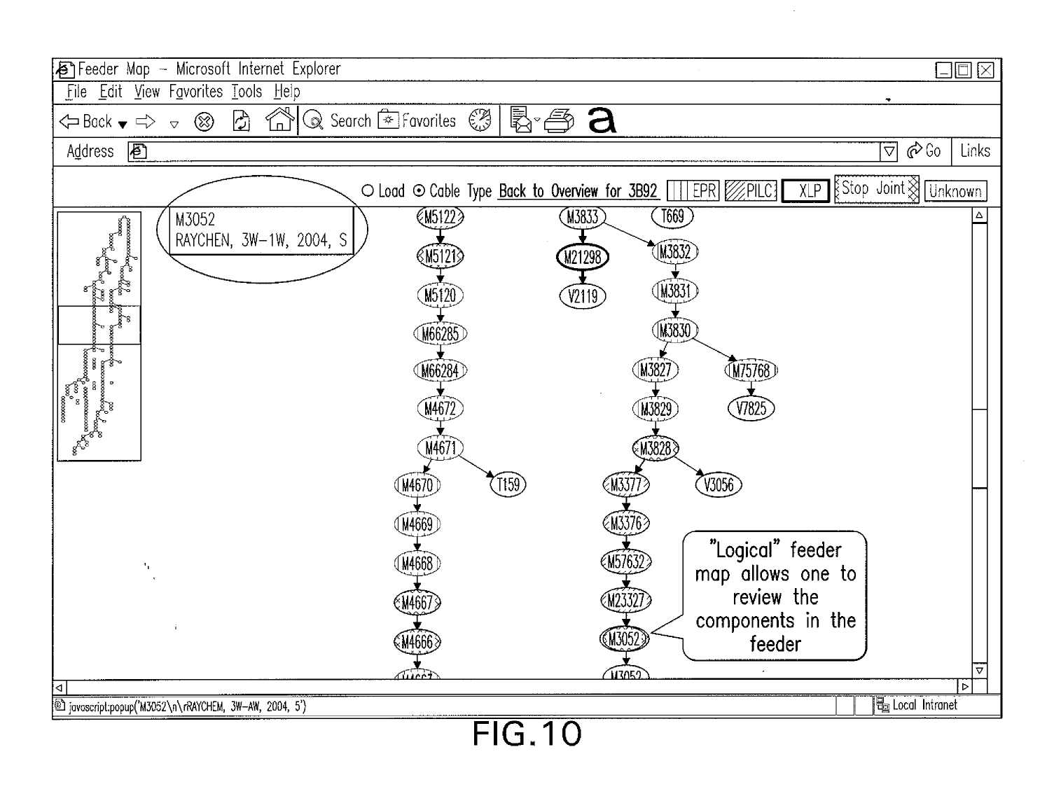

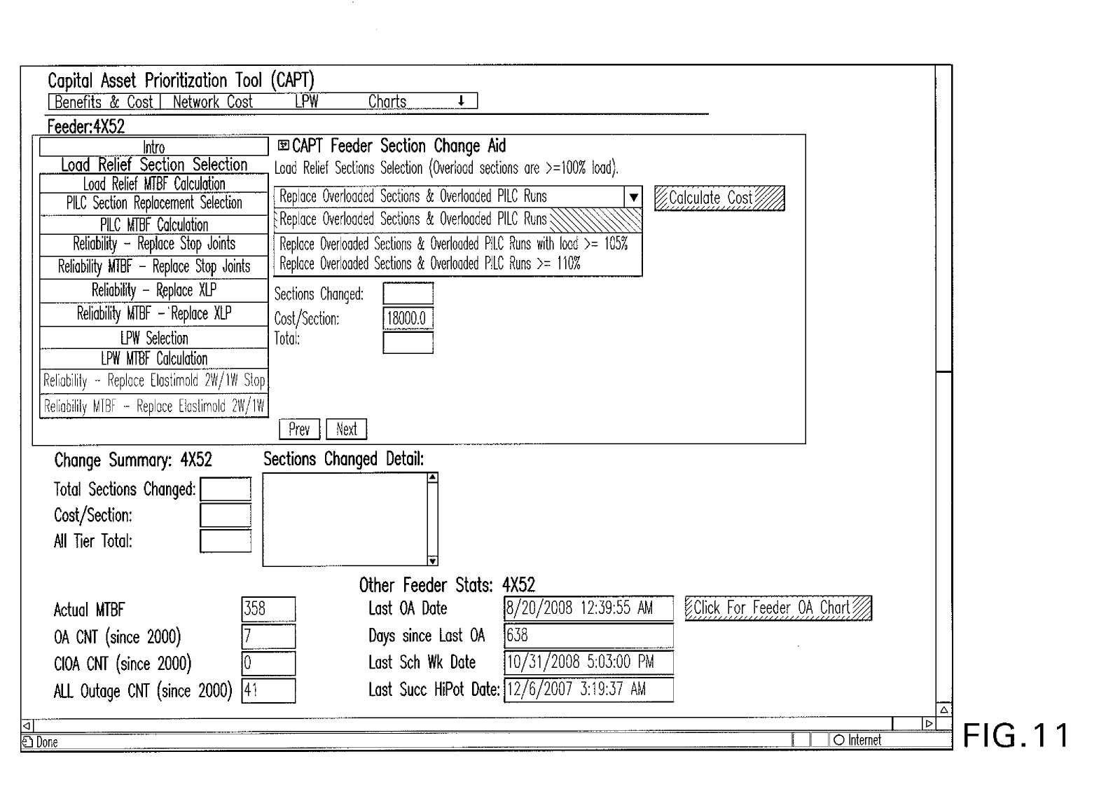

Various embodiments of the CAPT system provide mapping functionality. FIG. 8 is a topographical display of feeders in a particular network (3B), ranked according to their susceptibility to failure. Higher “window panes” or bars indicate a higher likelihood of failure for each feeder section. FIG. 9 is a topographical display of cable sections ranked according to their susceptibility to impending failure. Again, higher panes or bars indicate a higher likelihood of failure. FIG. 10 provides an alternative display of feeder components, such as stop joints, cable sections and manhole information.

FIG. 11 displays an alternative embodiment of the presently disclosed subject matter, in which the cost/benefit of capital improvement projects is determined in view of providing load relief to cable sections and runs of a feeder, as opposed to being in view of replacing PILC cable with more modern cable as in the previous example. A user can select that all overloaded sections and overloaded PILC runs overloaded at more than 100% or rating be replaced, or only those sections and runs that are overloaded by more than 105%, or more than 110% based on the section and run ratings. It is noted that, alternatively, the proposed capital improvement project can be also described in terms of system reliability, meaning operations and maintenance performance instead of, for example, in terms of capital PILC cable replacement, or in terms of cable and run load.

In an alternative embodiment, a “tiered strategy” can be employed to additively provide a strategy for proposed capital improvement projects. In one example, the first mandate is to replace all overloaded sections (Tier 1), then the mandated yearly replacement of PILC sections (Tier 2)—only a fraction of which is feasible to replace in any one year, and then reliability improvements comprising replacing XLP cable or replacing stop joints, if there is remaining budget (Tier 3). Operationally, Load Pocket Weight (Tier 4) can then be evaluated by comparing cost vs MTBF benefit for closing transformer switches that are currently open, bringing transformer banks that are currently offline back online, repairing low voltage cables called Open Mains, and/or repairing SCADA reporting problems. In this example, the CAPT system is careful in that selections of cable sections in Tier 1 are not available for replacement in Tier 2 or Tier 3 actions to avoid double-counting, and that different combinations of Tier 4 work activities can be summed to produce additional operational risk reduction via increased MTBF at times of stress to the electric grid and its feeders (such as peak summer heat days). Also cable selections chosen in Tier 2 are not available in Tier 3. In addition, reliability actions in each Tier are additive to other actions chosen for every other Tier so that decisions can be made within each Tier and in the overall, combined work plan for the portfolio of all Tiers.

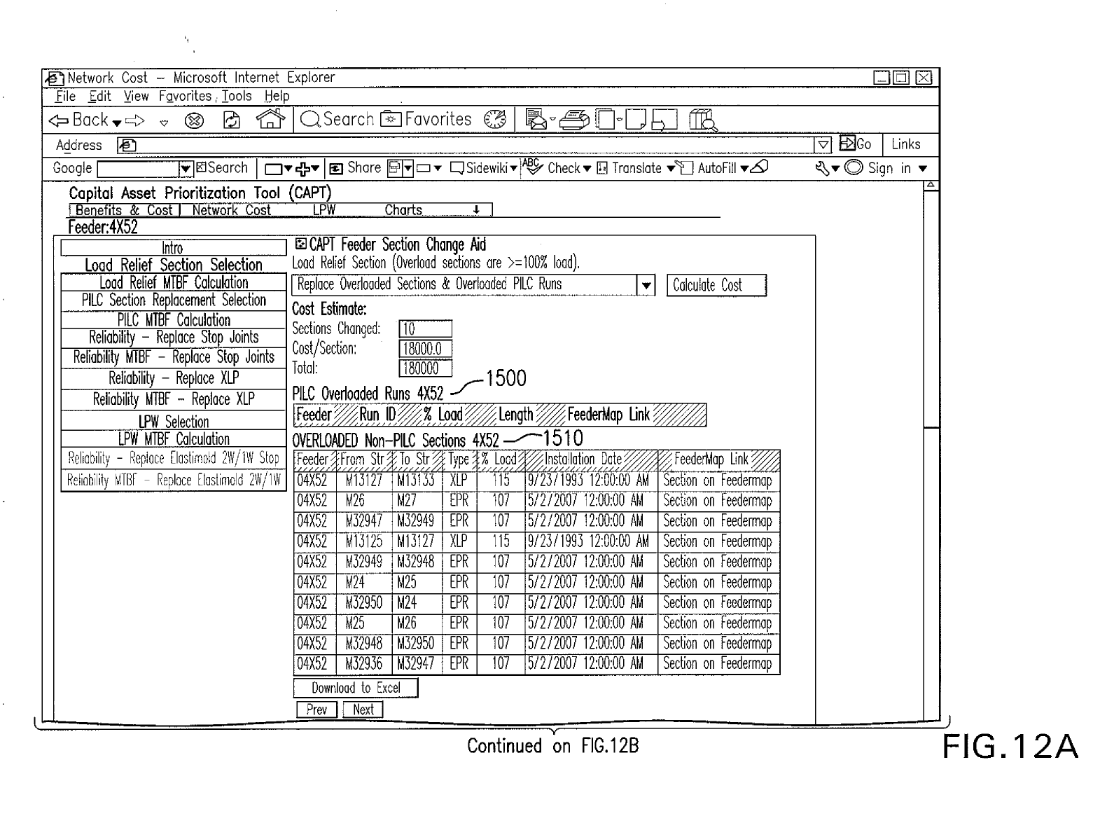

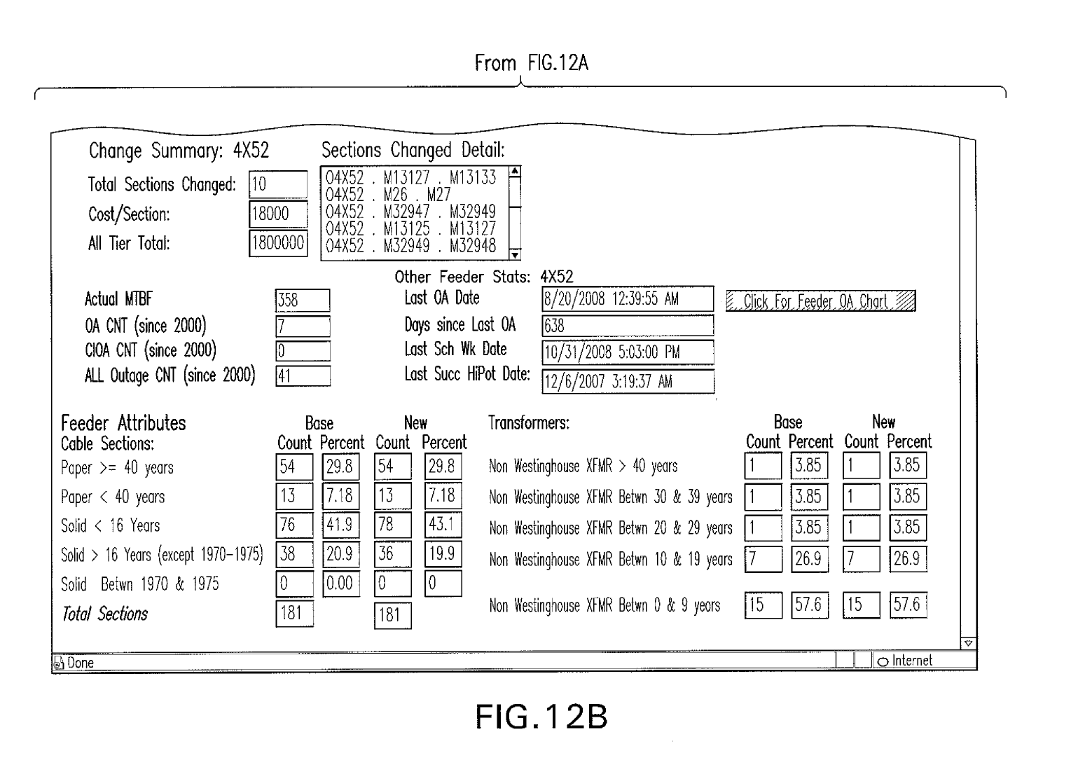

FIG. 12 provides more detail on replacement strategy that is based on the load of the sections (Tier 1 as identified above) and PILC runs (Tier 2 as identified above). For a particular feeder (4X52), in which the user has selected that all overloaded sections and overloaded PILC runs be replaced, the CAPT systems displays specifics about the overloaded runs (1500) and overloaded non-PILC sections (1510). Similar to outputs in which capital improvement projects are proposed based on % of PILC cable replacement, the CAPT system details feeder statistics and attributes (e.g., transformer data, cable section data) based on capital improvement projects that are prioritized based on load data.

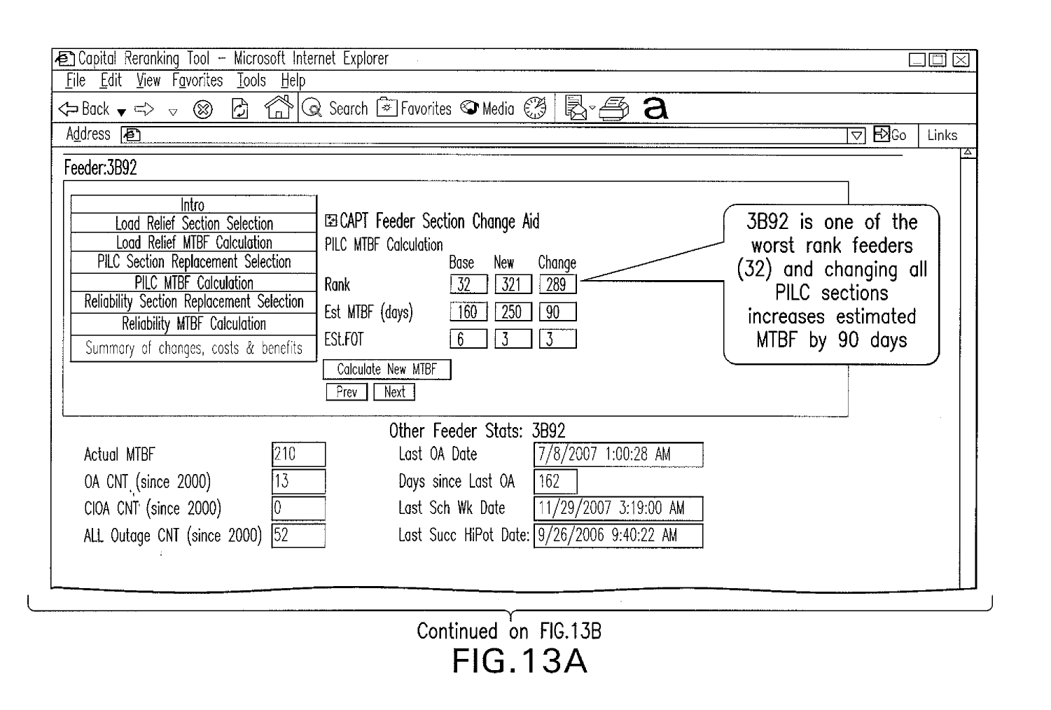

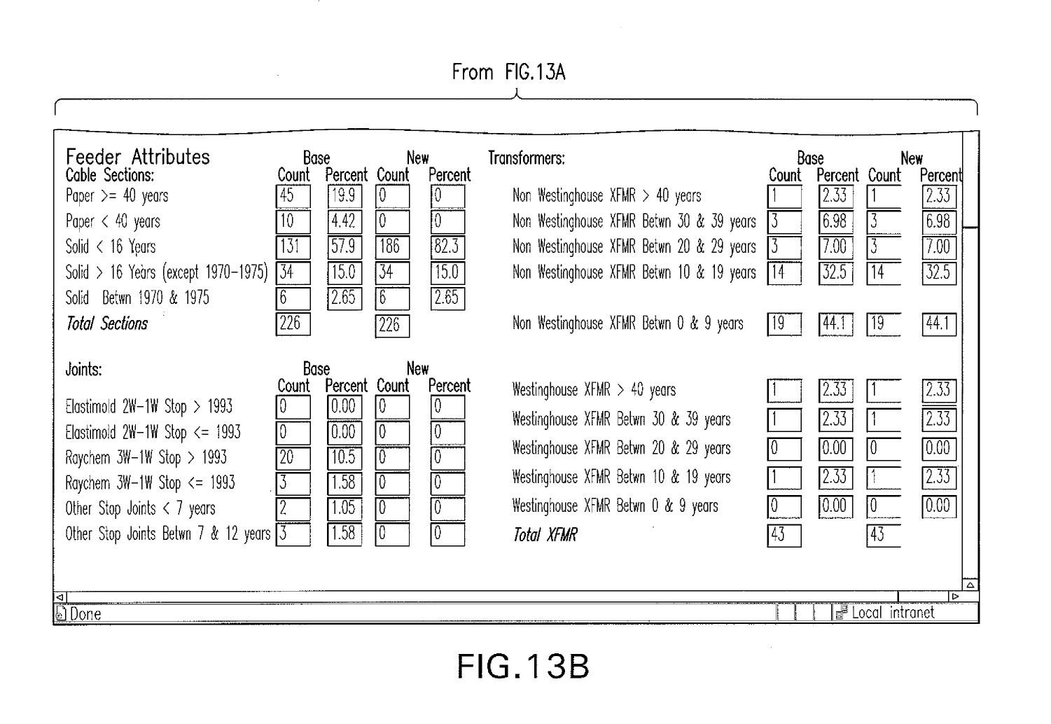

FIG. 13 provides estimated MTBF and delta MTBF data for a capital improvement project that is planned based on the replacement of PILC sections. In this particular example, the number of PILC cable sections is reduced from 55 to 0 in feeder 3B92. This increases the estimated MTBF by 90 days and improves the susceptibility to failure rank of the feeder from 32 to 289.

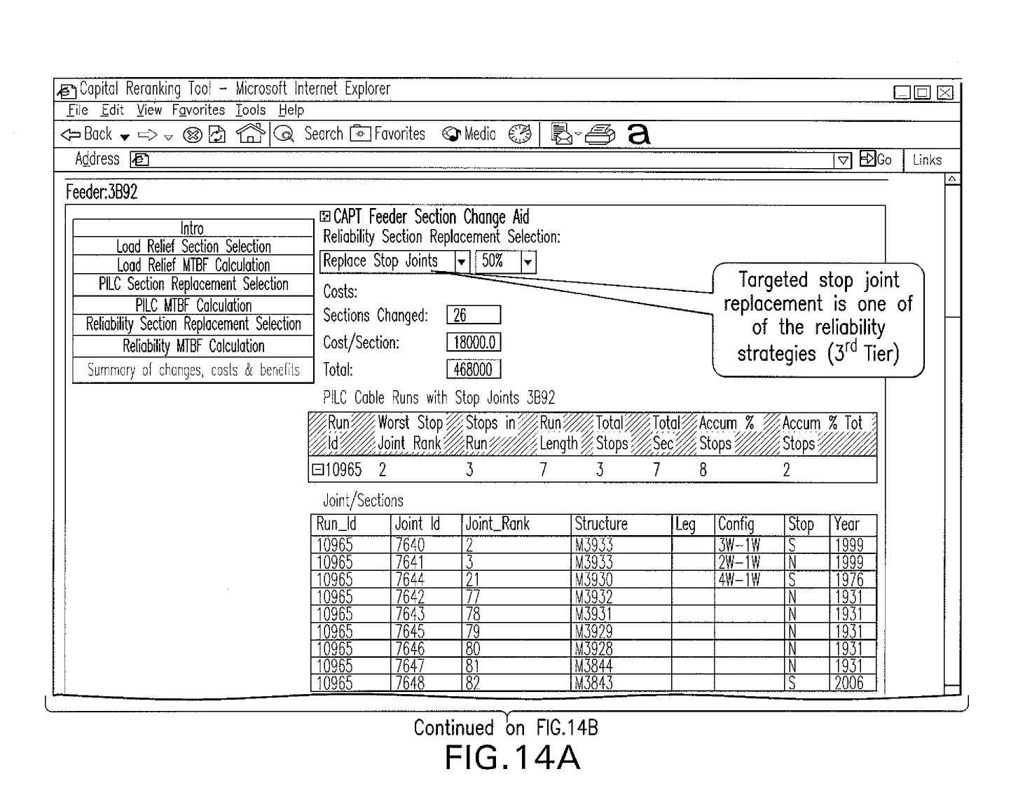

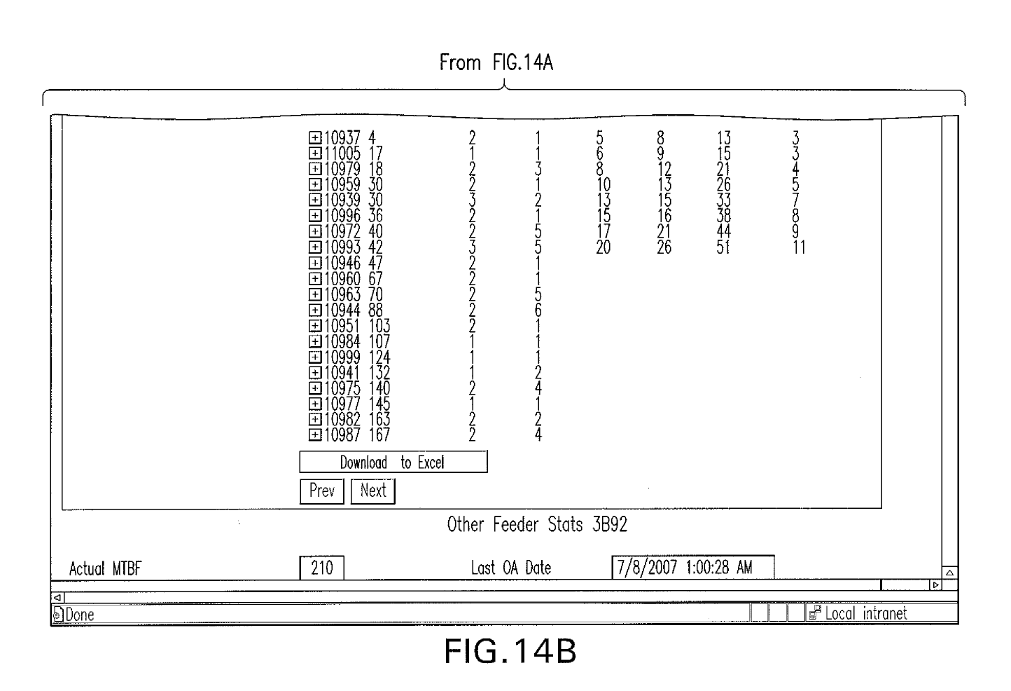

FIG. 14 provides an example of a proposed capital improvement project that is prioritized based on system reliability. In this example, stop joints are targeted for replacement based on their susceptibility to failure.

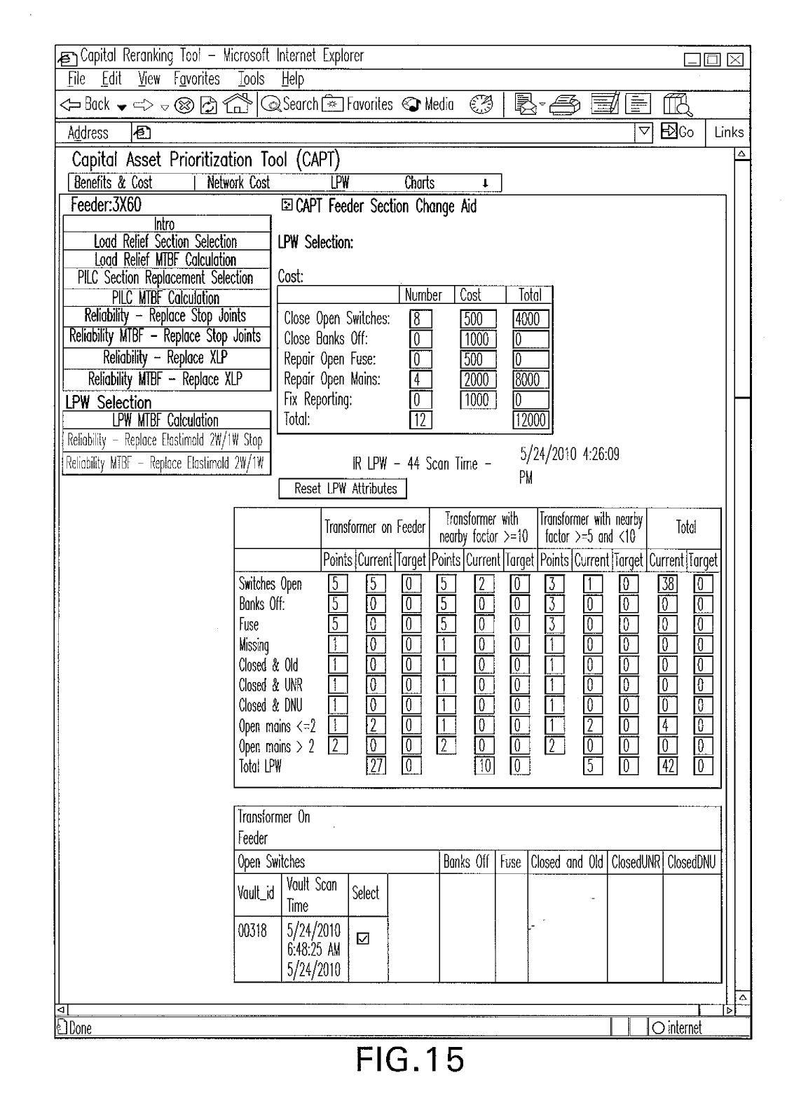

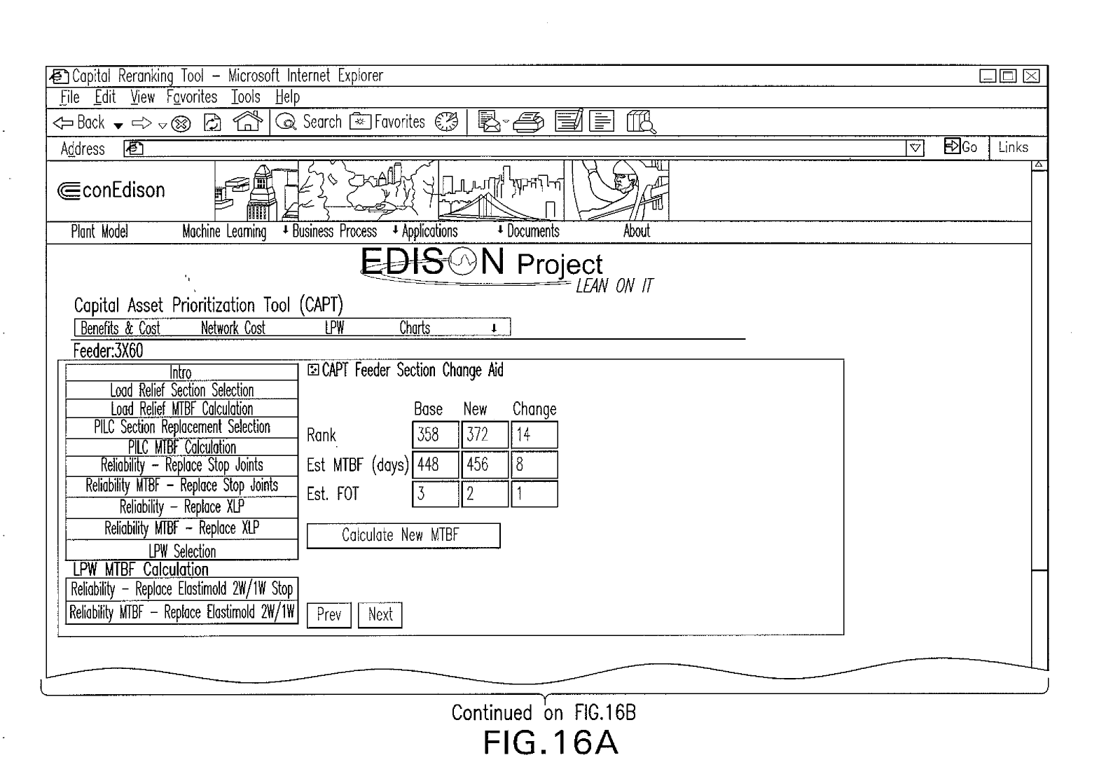

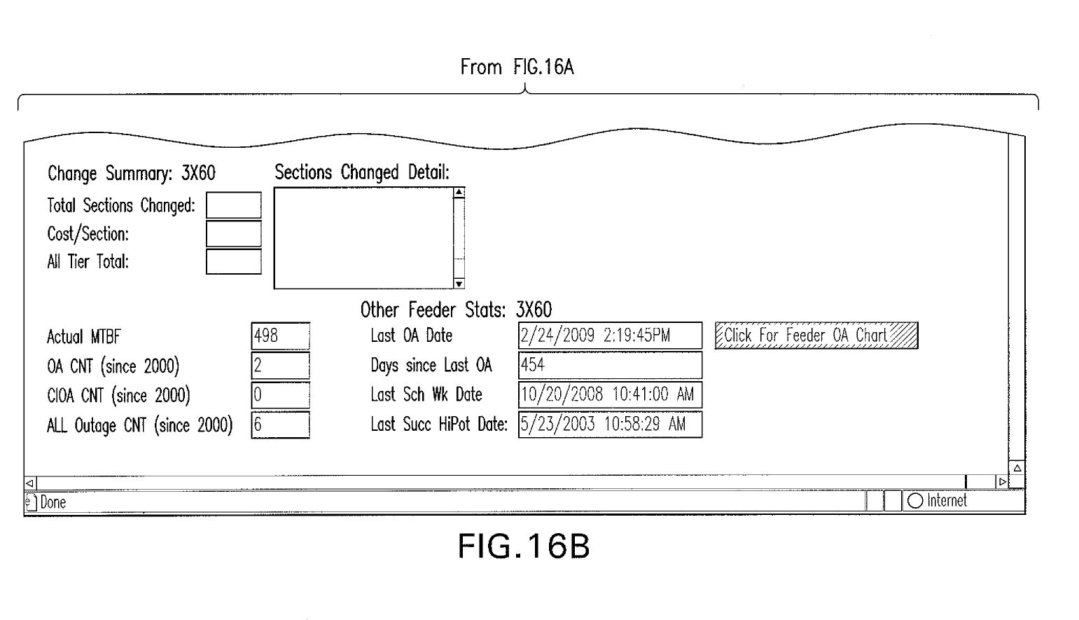

FIG. 15 provides a depiction of an additional alternative embodiment according to the presently disclosed subject matter, in which the attribute “Load Pocket Weight” is used as a basis for formulating a proposed operations and maintenance improvement strategy (Tier 4), and the strategy thus proposed is similarly analyzed to determine maximum “bang for the buck,” (e.g., delta MTBF vs. cost). Generally, Load Pocket Weight (LPW) is a metric used to define trouble in transferring load from local geographic load pockets of a feeder to the secondary grid via transformers in the distribution network (thusly the Load Pocket Weight nomenclature). Various indicators of such trouble, like as “open (transformer) switches (circuit breakers),” “banks off transformers offline for various maintenance reasons (e.g., “Live End Capping” that severs several transformers at a terminus of the feeder in order to get the rest of the feeder back online in a load crisis), “open fuses” also for network or circuit protection, “open mains” or secondary cable that is burned out, and Supervisory Control And Data Acquisition (SCADA) reporting problems such as “missing”, “open” and “old” SCADA readings, etc., are assigned point values and the total used to indicate where Load Pocket problems are via this total Weight. The proposed capital, operations and maintenance improvement project is then planned using the CAPT tool based on “lowering towards zero” the total load pocket weight of a feeder, i.e., actions are proposed like “close open switches,” “bring online banks off When Ready (WR),” “repair open fuses,” “repair open mains,” and “fix reporting problems” that reduce the LPW toward zero. As shown in FIG. 16, a delta MTBF can be determined based on the ODDS predictions of MTBF improvement from actions taken to reduce the load pocket weight.

Alternatively, the LPW itself can become one of the performance metrics of the CAPT system. A user can select individual maintenance actions to the infrastructure, and the projected LPW based on the changes can be compared to the projected LPW based on the current status of the infrastructure.

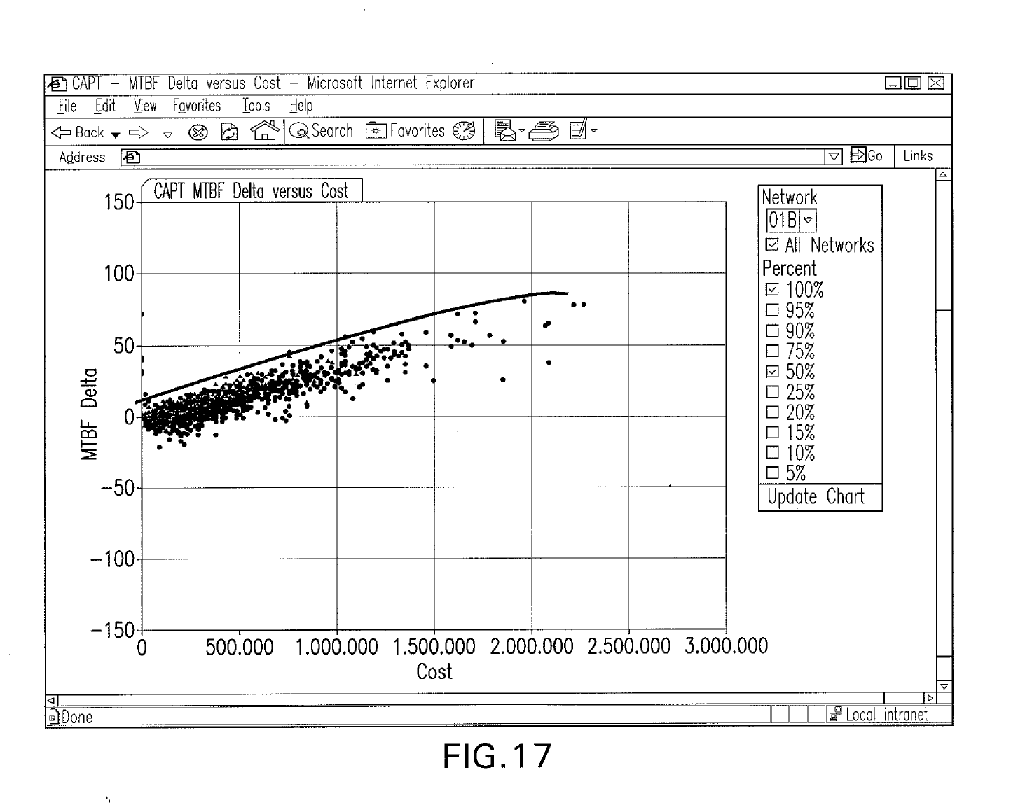

FIG. 17 exemplifies a methodology for determining the capital improvement project with the best for the buck for multiple feeders in multiple networks, circuits, or electric grids. Data points corresponding to the cost and delta MTBF for replacing, for example, 50% or 100% of the PILC cable sections in the various feeders are provided. The percentage of PILC cable replaced is a user-specified parameter. Excluding outliers, the upper range of the curve, i.e., those points with the highest delta MTBF for a given cost, define an efficient frontier in portfolio management theory and should receive priority given a limited capital improvement budget.

While the CAPT web application is described largely in the context of a capital, operations and maintenance improvement project within an electrical grid (e.g., replacing stop joints and PILC cable sections in electrical feeders), it is important to note that it is equally applicable to a wide range of other capital improvement, operations and preventive maintenance processes, including but not limited to, chemical processing operations, product manufacturing operations, telecommunications, transportation, civil, gas, pipeline, storage, steam, water, sewer, subway, rail, solar, wind, nuclear and other infrastructure projects. So long as there is a quantifiable performance metric associated with the capital, operations and maintenance improvement, and one or more attributes that also affect the performance metric besides the capital improvement project itself, the CAPT methods of the present application can be used to estimate the costs vs benefits of the improvement project, individually and in totum for the portfolio of the activity.

In the context of an electrical grid, the performance metric can be, for example, based on the failure (or non-failure) of the component under investigation. Attributes are selected that also impact whether or not the component of the electrical grid fails in the future. In this particular context, attributes can be obtained, for example, based on the results of a “marti-ranking” machine learning algorithm disclosed in International Published Application No. WO 2007/087537, which is hereby incorporated by reference in its entirety.

When a feeder fails, its substation protection circuitry will isolate if from its power supply in the substation automatically, which is know in the art as an “open auto” or “OA.” In one embodiment, the attribute value is the number of OA failures of the feeder under investigation for specified time period, termed the Mean Time Between Failures (MTBF). In another embodiment, the attribute is the number of all emergency outages except planned (SCHEDULED) and including Out on Emergency outages (OOE1, OOE2) identified by the field workers upon examination of specific equipment. For example, the attribute value in one embodiment can be the number of OA outages, “fail on test” outages (“FOT”), and “cut-in open auto” (“CIOA”) failures that open upon initial energization after a repair of any kind.

Additional details regarding the machine learning techniques that can be used in accordance with the presently disclosed systems and methods can be found in U.S. Pat. No. 7,395,252, which is hereby incorporated by reference.

It will be understood that the foregoing is only illustrative of the principles of the disclosed subject matter, and that various modifications can be made by those skilled in the art without departing from the scope and spirit thereof.

1. A capital asset planning system for selecting assets for improvement within an infrastructure comprising:
(a) one or more data sources descriptive of the infrastructure;
(b) one or more databases, coupled to the one or more data sources, to compile the one or more data sources;
(c) one or more processors, each coupled to and having respective communication interfaces to receive data from the one or more databases, the one or more processors comprising a predictor to generate:
(i) a first metric of estimated infrastructure effectiveness based, at least in part, on a current status of the infrastructure;
(ii) a second metric of estimated infrastructure effectiveness based, at least in part, on a user-selected, proposed changed configuration of the infrastructure; and
(iii) a net metric of infrastructure effectiveness based, at least in part, on said first metric and said second metric; and
(d) a display, coupled to have the one or more processors, for visually presenting the net metric of infrastructure effectiveness;
wherein the assets for improvement are selected based, at least in part, on the net metric of infrastructure effectiveness.

2. The capital asset planning system of claim 1, wherein the first metric of infrastructure effectiveness and the second metric of infrastructure effectiveness are both based, at least in part, on an estimated length of time that the infrastructure produces a commodity.

3. The capital asset planning system of claim 1, wherein the infrastructure is selected from the group consisting of a chemical processing operation, a petroleum refining operation, a product manufacturing operation, a telecommunication grid, a transportation infrastructure, a gas network, a commodity pipeline network, and a water treatment network.

4. The capital asset planning system of claim 1, wherein the infrastructure is an electrical grid.

5. The capital asset planning system of claim 4, wherein the first metric of infrastructure effectiveness and the second metric of infrastructure effectiveness are based, at least in part, on the estimated mean time between failure of one or more components of the electrical grid.

6. The capital asset planning system of claim 4, wherein the one or more data sources descriptive of the infrastructure include data representative of at least one of electrical feeder data, electrical cable data, electrical joint data, electrical transformer data, electrical outage data, electrical test pass or fail data, electrical load data, and past capital improvement cost data.

7. The capital asset planning system of claim 4, wherein the first metric of infrastructure effectiveness and the second metric of infrastructure effectiveness is estimated using a feeder index, said index based, at least in part, on a predicted likelihood of feeder failure.

8. The capital asset planning system of claim 7, wherein the predicted likelihood of feeder failure is obtained using machine learning.

9. The capital asset planning system of claim 7, wherein the feeder index is recalculated based, at least in part, on observed and previously predicted feeder data.

10. The capital asset planning system of claim 5, wherein the estimated mean time between failure is the estimated mean time between failure of an electrical feeder.

11. The capital asset planning system of claim 1, wherein the predictor further generates a cost metric based, at least in part, on the cost of the user-selected, proposed change of the infrastructure.

12. The capital asset planning system of claim 11, wherein the cost metric is generated based, at least in part, on a user-specified cost of one or more specific actions encompassed by the user-selected, proposed change of the infrastructure.

13. The capital asset planning system of claim 11, wherein the one or more data sources include past capital improvement cost data, and the cost metric is based, at least in part, on past capital improvement cost data.

14. The capital asset planning system of claim 1, wherein the predictor further comprises a prioritizer to determine the user-selected, proposed changed configuration of the infrastructure that provides the maximum value based, at least in part, on the net metric of infrastructure effectiveness and the cost metric.

15. A method for selecting assets for improvement within an infrastructure comprising:
(a) accessing one or more data sources descriptive of the infrastructure;
(b) compiling the one or more data sources into one or more databases;
(c) generating a first metric of estimated infrastructure effectiveness based, at least in part, on a current status of the infrastructure;
(d) generating a second metric of estimated infrastructure effectiveness based, at least in part, on a user-selected, proposed changed configuration of the infrastructure; and
(e) generating a net metric of infrastructure effectiveness based, at least in part, on said first metric and said second metric; and
(f) displaying the net metric of infrastructure effectiveness,
wherein the assets for improvement are selected based, at least in part, on the net metric of infrastructure effectiveness.

16. The method for selecting assets for improvement of claim 15 wherein the infrastructure is an electrical grid, and said first metric, said second metric and said net metric is based, at least in part, on the estimated mean time between failure of an electrical feeder within the electrical grid.

17. The method for selecting assets for improvement of claim 15, wherein the first metric of infrastructure effectiveness and the second metric of infrastructure effectiveness is estimated using a feeder index, said index based, at least in part, on a predicted likelihood of feeder failure.

18. The method for selecting assets for improvement of claim 15, further comprising generating a cost metric based on the cost of the user-selected, proposed change of the infrastructure.

19. The method for selecting assets for improvement of claim 15, further comprising determining the user-selected, proposed changed configuration of the infrastructure that provides the maximum value based on the net metric of infrastructure effectiveness and the cost metric.

20. A capital asset planning system for selecting assets for improvement within an electrical grid comprising:
(a) one or more data sources descriptive of the infrastructure selected from electrical feeder data, electrical cable data, electrical joint data, electrical transformer data, electrical outage data, electrical test pass or fail data, electrical load data, and past capital improvement cost data;
(b) one or more databases, coupled to the one or more data sources, to compile the one or more data sources;
(c) one or more processors, each coupled to the one or more databases and having respective communication interfaces to receive data from the one or more databases, the one or more processors comprising a predictor to generate:
(i) an estimated baseline mean time between failure of an electrical feeder;
(ii) an estimated projected mean time between failure of an electrical feeder based, at least in part, on a user-selected, proposed changed configuration of the electrical grid; and
(iii) a net mean time between failure based, at least in part on the estimated baseline mean time between failure and the estimated projected mean time between failure; and
(d) a display, coupled to have the one or more processors, for visually presenting the net metric of infrastructure effectiveness and a cost metric of the proposed changed configuration of the electrical grid,
wherein the capital asset planning system provides the ability to select assets for improvement based, at least in part, on the net mean time between failure and the cost metric.
